(19) United States
(12) Patent Application Publication
(10) Pub. No.: US 2008/0189144 A1
(43) Pub. Date: Aug. 7, 2008

(54) System and Method of Providing Travel-related Tools for Use with Transportation Services

(75) Inventor: Charles Wurster, Buckeye, AZ (US)

Correspondence Address: QUARLES & BRADY LLP, RENAISSANCE ONE, TWO NORTH CENTRAL AVENUE, PHOENIX, AZ, 85004-2391, US

(73) Assignee: MACH 9 TRAVEL, LLC, Buckeye, AZ (US)

(21) Appl. No.: 11/670,727

(22) Filed: Feb. 2, 2007

(51) Int. Cl. G06Q 10/00

(52) U.S. Cl. 705/5

(57) ABSTRACT

A computer system makes reservations for transportation services. Vendor information for rental resources is stored in a central database. A customer makes a reservation inquiry. The central database is searched to find availability of the rental resources for the reservation inquiry. A rate is calculated for the rental resources based on customer-supplied and vendor-supplied information, as well as public sources. The availability of the rental resources and rates are reported to the customer. The customer selects the desired rental resources. The customer selection is confirmed with the vendor. An estimate of charges is provided initially and then updated following the customer's use of the reserved rental resources. Vendor payments are aggregated for multiple reservations. Travel-related tools are provided for the customer while utilizing the reserved rental resources. If one vendor cannot service a customer, the system transfers the reservation to another affiliated vendor.

### CROSS-REFERENCE TO RELATED PATENT APPLICATIONS

The present patent application is related to copending U.S. patent application Ser. No. ______, Attorney Docket No. 126570.00003, entitled “System and Method of Providing Transportation Services,” and filed concurrently herewith. The present patent application is further related to copending U.S. patent application Ser. No. ______, Attorney Docket No. 126570.00004, entitled “System and Method of Calculating Rates for Use of Transportation Services,” and filed concurrently herewith. The present patent application is further related to copending U.S. patent application Ser. No. ______, Attorney Docket No. 126570.00005, entitled “System and Method of Transferring Reservations for Transportation Services,” and filed concurrently herewith. The present patent application is further related to copending U.S. patent application Ser. No. ______, Attorney Docket No. 126570.00007, entitled “System and Method of Determining Rental Resource Availability for Transportation Services,” and filed concurrently herewith.

### FIELD OF THE INVENTION

The present invention relates in general to computer-based commercial services and, more particularly, to a system and method of providing travel-related tools for use with transportation services.

### BACKGROUND OF THE INVENTION

The traveling public often utilizes transportation services in daily business and personal activities. People frequently have a need to use public and private transportation services to get from one place to another. For example, a customer may need to call upon a taxi to get across town to a meeting or to the airport. The customer may need a rental car for vacation or business travel. The customer may want to rent a limousine to pick-up a client or enjoy an evening on-the-town. The customer may want to rent a moving truck. In any case, for the customer wanting to reserve a vehicle, there are well-known steps to arrange for the transportation services. Rental companies are known to provide such transportation services.

Most if not all logistics involved in utilizing transportation services are handled individually by each rental company. There is little or no interaction between transportation service companies. In fact, due to the intense competition, most companies are unwilling to share any information. Each company must handle its own reservations, client service, advertising, marketing, accounting, confirmation, rental agreements, fleet maintenance, scheduling changes, breakdowns, overbooking, and dispatching. The duplication and replication of efforts over the transportation service industry as a whole is highly inefficient and many times ineffective.

In one approach, the customer needing transportation services turns to advertising and information resources, e.g., Yellow Pages, internet search engines, hotel concierge, or travel agent. These information resources typically list the transportation services on a company-by-company basis. If the customer looks up taxi services in the Yellow Pages or searches for rental car agencies on the internet, he or she will get a number of hits of individual companies. Transportation services generally have many competitors in each transportation category, i.e., there are many different taxi companies, rental car agencies, limousine vendors, airlines, etc. Each company will have its own products, services, pricing, promotions, and reputation. It is highly unlikely that one company will have, or be willing to share, any information regarding another company, as each may be in competition with the other. To make the necessary checks and to reserve the needed vehicle, the customer will have to call, email, or otherwise contact one or more of the transportation service companies that deal in the products and services of their interest. If the customer is limited on time, he or she may select the first company that can meet their needs, regardless of price. If the customer wants to shop around, he or she can spend considerable time and effort comparing products, services, pricing, and promotions between the various companies within their transportation service category.

Once the customer selects the transportation service company, a confirmation is generated and rental agreement is sent to the customer via email, facsimile, or postal service for signature. The transportation service is performed and the customer is billed for the service by invoice, credit card, or other payment method. The billing and payment is handled directly with the vendor.

The rental rates between companies are often highly variable. There is little reasoning and logic behind setting rates other than the company will charge what the market will bear. Owners of rental companies usually hope for a profit after tallying revenue and accounting for all expenses.

The process involved in the transportation service company answering questions, generating the rental agreement, making adjustments for customer changes, and billing the customer is very time consuming, often requiring many hours per reservation. The time required for marketing, client service, confirmations, contracts, recordkeeping, and accounting is inefficient and cuts into the profits of a highly competitive business.

Another problem with the present transportation service business model involves the logistics of dispatching drivers to customers. The transportation service company may provide the driver a schedule at the beginning of each work shift, or communicate with the driver by radio or cell phone. The dispatcher often does not know the driver's location or which resources are most readily available for an immediate rental request. If the needs of the customer change, then the driver's plans can be significantly altered, which can ripple through the entire schedule. The human factor involved in arranging for and dispatching transportation services is always prone to error and mistakes.

When a transportation service company overbooks or experiences a breakdown or otherwise cannot fulfill a customer request, it must cancel the rental agreement or undertake the time and expense of arranging for alternate transportation services, i.e., the company must make the same calls that the original customer makes trying to find substitute transportation services. Again, the cost involved in searching for other transportation services reduces profits and creates inefficiencies in the highly competitive market.

A need exists for a more efficient process of utilizing transportation services.

### SUMMARY OF THE INVENTION

In one embodiment, the present invention is a computer-implemented method of providing travel-related tools for use with transportation services comprising the steps of providing a transportation service system which receives reservation inquiries from customers, presents vendor rental resources matching the reservation inquiries, and books the rental resource upon selection by the customer, and providing a plurality of travel-related tools for the customer to use before and during rendition of the transportation services.

In another embodiment, the present invention is a computer-implemented method of providing travel-related tools for use with transportation services comprising the steps of providing a transportation service system for booking rental resources, and providing a plurality of travel-related tools for use during rendition of the transportation services.

In another embodiment, the present invention is a computer program product usable with a programmable computer processor having computer readable program code embodied therein comprising computer readable program code which provides for a transportation service system which receives reservation inquiries from customers, presents vendor rental resources matching the reservation inquiries, and books the rental resource upon selection by the customer, and computer readable program code which provides a plurality of travel-related tools for the customer to use before and during rendition of the transportation services.

In another embodiment, the present invention is a computer system for providing travel-related tools for use with transportation services comprising means for providing a transportation service system which receives reservation inquiries from customers, presents vendor rental resources matching the reservation inquiries, and books the rental resource upon selection by the customer, and means for providing a plurality of travel-related tools for the customer to use before and during rendition of the transportation services.

### BRIEF DESCRIPTION OF THE DRAWINGS

FIG. 1 is a block diagram showing a process of providing transportation services;

FIG. 2 is a computer system for executing the process of providing transportation services;

FIG. 3 is a block diagram of the transportation service system;

FIG. 4 is a data entry screen for reservation requests for transportation services;

FIG. 5 illustrates a block diagram for determining availability of rental resources;

FIG. 6 illustrates a driving route for calculating rates for the rental resources;

FIG. 7 is a table listing rental resources with estimated pricing based on customer reservation inquiry;

FIG. 8 is a data entry screen for dispatching information for transportation services;

FIG. 9 is a data entry screen for billing information for transportation services;

FIG. 10 is a data entry screen for posting transportation services rendered;

FIG. 11 is a vendor report for managing transportation services;

FIG. 12 is a screen for presenting reservation history;

FIG. 13 is a block diagram of travel-related tools for use with transportation services;

FIG. 14 is a block diagram for transferring reservations for transportation services;

FIG. 15 is a data entry screen for vendor vehicle information;

FIG. 16 is an alternate embodiment of the data entry screen for reservation requests for transportation services;

FIG. 17 is a data entry screen for passenger information;

FIG. 18 is a data entry screen for the trip itinerary;

FIG. 19 is a data entry screen for billing information;

FIG. 20 is a data entry screen for searching for existing reservations;

FIG. 21 is a data entry screen for reservation reporting;

FIG. 22 is a data entry screen to farm-out reservations to affiliated vendors;

FIG. 23 is a data entry screen for selecting special deals; and

FIG. 24 illustrates the steps of providing transportation services.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Transportation service is an important function used by many people. People frequently have a need to use public and private transportation services to get from one place to another. Everyday, hundreds of thousands of limousine, shuttle bus, and motor coach reservations are made globally. The world's ground transportation industry traverses a vast retail and corporate marketplace. About fifty percent of ground travel is corporate travel and the other fifty percent is from retail customers.

In simple terms, the process of using transportation services typically involves making a reservation, rendering the transportation, and then paying the bill. The present transportation reservation system simplifies and increases the efficiency for users of transportation services, although the system is applicable to other service functions as discussed below. The system is available for nationwide and worldwide service and adaptable to provide advice and fill many travel needs. Some of the services available with the present system include rental of taxi, limousine, shuttle, motor coach, automobile, truck, train, aircraft, or marine vessel for a given purpose, e.g., business, vacation, weddings, city tour, birthdays, high school prom, anniversaries, and graduation. For example, a customer may call upon a taxi to get across town to a meeting or to the airport. The customer may want to rent a limousine to pick-up a client or enjoy an evening on-the-town. The customer may want to make an airline reservation or book an ocean cruise.

The present transportation service system specializes in the coordination and management of global ground transportation for corporations, retail clients, destination management companies, travel agents, transportation companies, and the like. The present transportation service system saves significant time and money in the rental process.

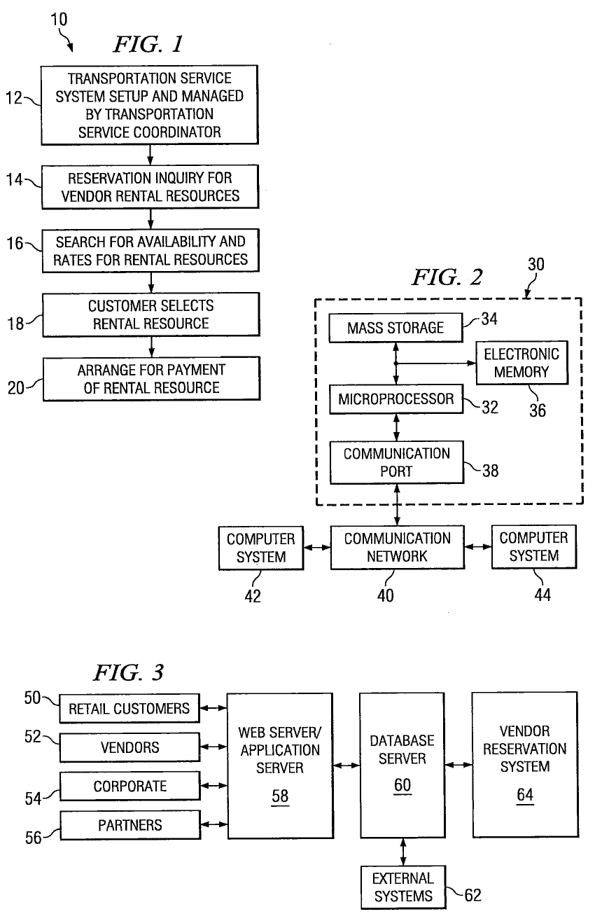

The present transportation service process 10 is shown in FIG. 1. Transportation service process 10 automates the booking process including the initial reservation, order distribution to vendors, scheduler, vehicle availability, and change or cancel reservation requests. In block 12, the transportation service system 10 is set-up by the transportation service coordinator. The service coordinator operates as a third party, independent and apart from the vendors, which manages the reservation system for transportation services for the benefit of vendors and customers alike. The transportation service system 10 contains an inventory of vendor's rental resources available for rent. The vendors utilize the transportation service system 10 for booking their fleet. In block 14, a customer makes a reservation inquiry for vendor rental resources. The customer may be a retail consumer, corporate client, another vendor, or partner of the transportation service system. The rental resource can be ground transportation, aircraft, marine vessel, commercial shipping, just to name a few. In block 16, system 10 searches a central database for availability and rates for the rental resources. The rates are calculated based on customer-supplied and vendor-supplied information, as well as public records. The availability and rates for the rental resources are reported back to the customer. In block 18, the customer makes a selection of the desired rental resources based on its availability and rate. The customer's selection of rental resources is confirmed with the vendor, including all necessary rental agreements. The customer then makes use of the rental resources. In block 20, system 10 arranges for payment from the customer and reconciles money due to the vendor. Payments to the vendor from multiple reservations are aggregated to simplify the accounting process.

FIG. 2 illustrates a simplified computer system 30 for executing the software program used in the transportation service system 10. Computer system 30 is a general-purpose computer including a central processing unit or microprocessor 32, mass storage device or hard disk 34, electronic memory 36, and communication port 38. Communication port 38 represents a modem, high-speed Ethernet link, or other electronic connection to transmit and receive input/output (I/O) data with respect to other computer systems.

Computer 30 is shown connected to communication network 40 by way of communication port 38. Communication network 40 can be a local and secure communication network such as an Ethernet network, global secure network, or open architecture such as the Internet. Computer systems 42 and 44 can be configured as shown for computer 30 or dedicated and secure data terminals. Computers 42 and 44 are also connected to communication network 40. Computers 30, 42, and 44 transmit and receive information and data over communication network 40.

When used as a standalone unit, computer 30 can be located in any convenient location. When used as part of a computer network, computers 30, 42, and 44 can be physically located in any location with access to a modem or communication link to network 40. For example, computer 30 can be located in the main office of the transportation service coordinator. Computer 42 can be located in a vendor's office. Computer 44 can be located in customer's home. Alternatively, the computers can be mobile and follow the users to any convenient location, e.g., remote offices, customer locations, hotel rooms, residences, vehicles, public places, or other locales with electronic access to communication network 40.

Each of the computers runs application software and computer programs which can be used to display user-interface screens, execute the functionality, and provide the features of the transportation service system 10. In one embodiment, the screens and functionality come from the application software, i.e., the transportation service system 10 runs directly on one of the computer systems. Alternatively, the screens and functionality can be provided remotely from one or more websites on the Internet. The data entry screens described herein can be part of the application software running on a dedicated computer or part of a website accessed via the Internet. The websites are generally restricted-access and require passwords or other authorization for accessibility. Communications through such websites may be encrypted using secure encryption algorithms. Alternatively, the screens and functionality are accessible only on the secure private network, such as Virtual Private Network (VPN), with proper authorization.

The software is originally provided on computer-readable media, such as compact disks (CDs), magnetic tape, or other mass storage medium. Alternatively, the software is downloaded from electronic links such as the host or vendor website. The software is installed onto the computer system hard drive 34 and/or electronic memory 36, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having computer-readable program code embodied therein. The software contains one or more programming modules, subroutines, computer links, and compilations of executable code, which perform the functions of the transportation service system 10. The user interacts with the software via keyboard, mouse, voice recognition, and other user-interface devices connected to the computer system.

The software stores information and data related to the transportation services in a database or file structure located on any one of, or combination of, hard drives 34 of the computers 30, 42, and/or 44. More generally, the information used in the transportation service system 10 can be stored on any mass storage device accessible to computers 30, 42, and/or 44. The mass storage device for storing the transportation service data may be part of a distributed computer system.

In the case of Internet-based websites, the interface screens are implemented as one or more webpages for receiving, viewing, and transmitting information related to the transportation service system 10. A host service coordinator may set up and administer the website from computer 30 located in the service coordinator's home office. The rental agency accesses the webpages from computers 42 and 44 via communication network 30.

FIG. 3 illustrates a block diagram of the transportation service system 10. The users, including retail customers 50, vendors 52, corporate 54, and partners 56, interface via a messaging infrastructure such as transmission control protocol (TCP) or extensible markup language (XML) to web server/application server 58, which handles communication with the Internet and application software. Server 58 interacts with database server 60, which stores the data used by the transportation service system 10. The data storage includes vendor information, customer information, vehicle information, reservations, accounting, availability, rates, logistical information, and reporting. The application software executes the features of the transportation service system 10 as described below. Database server 60 also interacts with external systems 62 such as weather, traffic, and flight information. Database server 60 also interfaces with vendor reservation system 64, which represents the vendor's computer-based reservation system.

The transportation service system 10 is applicable to many different rental resources. A rental resource is any asset that can be temporarily used by the customer, from which a company wants to derive revenue. The rental resource can be ground transportation, aircraft, marine vessel, or commercial shipping. The rental resources could also be entertainment ticketing, professional services, customer services, and restaurants.

In one embodiment, the transportation service system 10 is described in terms of a ground transportation rental company, such as a limousine rental agency. The rental company rents out its fleet of limousines to customers on demand. The rental company signs up with the transportation service coordinator to utilize the transportation service system 10 to rent out its limousines. The rental company does not have to worry about marketing, booking, billing, or substitute services as all this is handled by the transportation service coordinator. The rental company can concentrate on servicing the customer. The transportation service system 10 will sign up many rental companies, whether competitors or not, to provide maximum value, choices, and service to the customer.

First consider retail customer 50 as the user of the transportation service system 10. In the present example, retail customer 50 accesses the transportation service system 10 via the Internet using computer 42. Retail customer 50 enters the uniform resource locator (URL) address of the transportation service system and is presented with the system home page. From the home page, retail customer 50 can make a reservation inquiry or request to use a rental resource, e.g., limousine or automobile. The rental resources are maintained and made available by a plurality of vendors, i.e., companies that provide transportation service directly to customers. For example, the vendors may rent limousines and other ground transportation to customers. The vendors store rental resource information in database 60. The rental resource information includes number and type of vehicle, passenger and luggage capacity, amenities, experience of drivers, availability, rates, and service area.

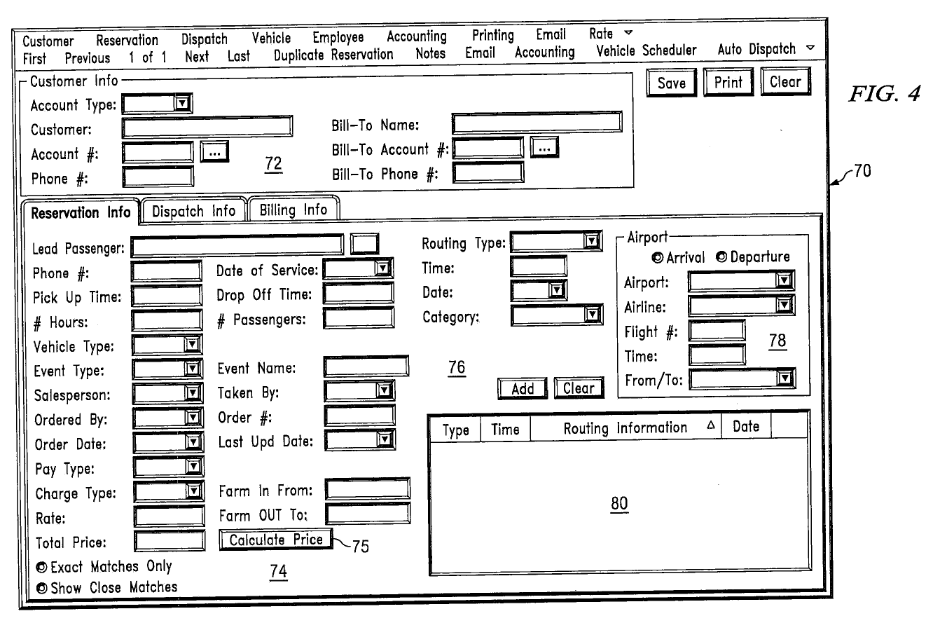

FIG. 4 illustrates a data entry screen or home webpage 70 designed for retail customer 50 to use the transportation service system 10. Screen 70 is an interface to the transportation service system 10 and is made available through a portal by the transportation service coordinator. Most webpages in the transportation service system 10 have selections or links across the top of the page for customer, reservation, dispatch, vehicle, employee, accounting, printing, email, rate, duplicate reservation, notes, accounting, vehicle scheduler, and auto dispatch. The data entry boxes or fields allow the user to enter data into system 10. Some fields are general purpose and will accept any data. Other fields accept only predetermined values and may have a pull-down selection menu.

In block 72, the user has fields for customer information such as account type, customer name, account number, phone number, bill-to name, bill-to account number, and bill-to phone number. Under reservation info tab, in block 74, the user has fields for lead passenger, phone number, date of service, pick-up time, drop-off time, number of hours, number of passengers, vehicle type, event type, event name, salesperson, taken by, ordered by, order number, order date, last update, pay type, charge type, farm-in from, rate, farm-out to, and total price. Button 75 allows the user to calculate price. Block 74 allows the user to select exact matches only or to let the system suggest rental resources closely aligned with the reservation inquiry. In block 76, the user has fields for routing type, time date, and category. In airport block 78, the user selects either arrival or departure and enters airport, airline, flight number, time, and from/to locations. Block 80 shows reservation information such as type, time, routing, and date. Some fields are for user data entry and other fields are determined by the system.

Retail customer 50 uses screen 70 to enter the information necessary to make a reservation inquiry or request within the transportation service system 10. The system searches database 60 based on the reservation information provided in screen 70. The search utilizes geographic information systems (GIS) mapping to find vendors with the customer's locale. System 10 checks the vendor's availability of rental resources that matches the reservation information.

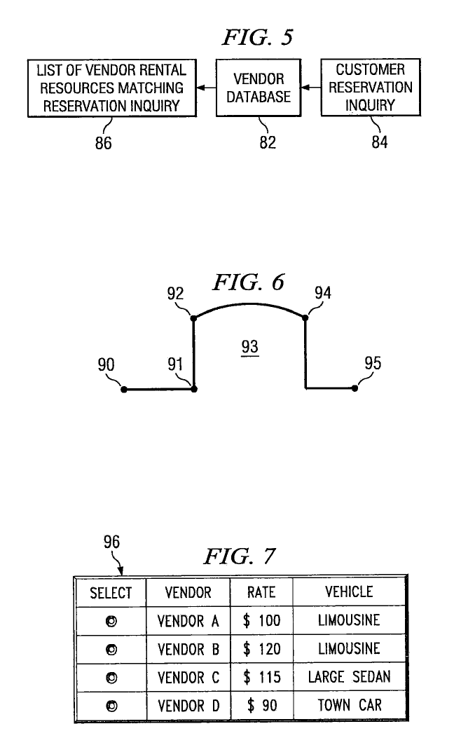

Further detail of the process of determining rental resource availability is shown in FIG. 5. For the representative ground transportation example, in block 82, the vendors provide vehicle information to the transportation service system database for each asset that they want to make available for rental. Recall that system 10 supports a plurality of vendors. Each vendor stores the vehicle information as records in the central database 60. The vehicle record contains items such as vehicle type, passenger capacity, load capacity, service area, and special features. For example, one vehicle may be identified as a stretch Hummer limousine with capacity for 10 people and 1000 lbs. of luggage. The limousine has a sunroof, fully stocked bar, and is available for service in the Phoenix metropolitan area. Each vendor will have a record in the database for each asset they want to make available to customers.

In block 84, the customer makes reservation inquiry to the transportation service system 10. The customer may want a limousine for six people. System 10 searches its database and retrieves records that match or closely align with the reservation request. The records for the rental resources in the central database are compared to the reservation inquiry to find matches. In some cases, the system selects records that exactly match the reservation inquiry, i.e., the selected vehicles may have more than the requested features in the reservation inquiry, but the selected vehicles must have at least the features requested in the reservation inquiry. Alternatively, the system may select vehicles that closely align with the reservation inquiry. For example, the customer may have requested a sedan-style stretch limousine. The system will retrieve records for the sedan-style, if any, but may also offer other types of stretch limousines that might accommodate the customer's needs, particularly if the number of hits for an exact match to the original reservation inquiry was low or zero. The customer might favorably consider the alternative choices once he or she sees the whole picture. Screen 70 in FIG. 4 includes the option for the customer to specify exact matches only or whether they want to see other rental resources that closely align with their reservation inquiry.

As part of the searching process to retrieve records that match or closely align with the customer's reservation request, the transportation service system 10 checks and confirms availability of the matching vehicles. System 10 maintains in the vendor database the present status of each vehicle based on confirmed reservations. If a particular vehicle is confirmed for reservation by a first customer during a specific time period, then that vehicle will be assigned a status as “not available” for the relevant time period and will be excluded from the search for a second customer during the same time period. System 10 further receives real-time updates from each vendor as to the status of each rental resource. If the vendor itself rents out a particular vehicle for a specific time period, then that vehicle will be assigned a status of “not available” for the relevant time period and will be excluded from the search by the customers of system 10. If the vehicle goes down for maintenance, then the vendor will notify the transportation service coordinator so the vehicle can be assigned a status of “not available” for the relevant time period and will be excluded from searches to satisfy the customer's reservation request. Likewise, if a customer cancels a reservation of a vehicle, then the status of the vehicle is returned to “available” for subsequent searches. System 10 is updated in real-time to maintain the current status of the rental resources in the central database as to availability of the rental resources.

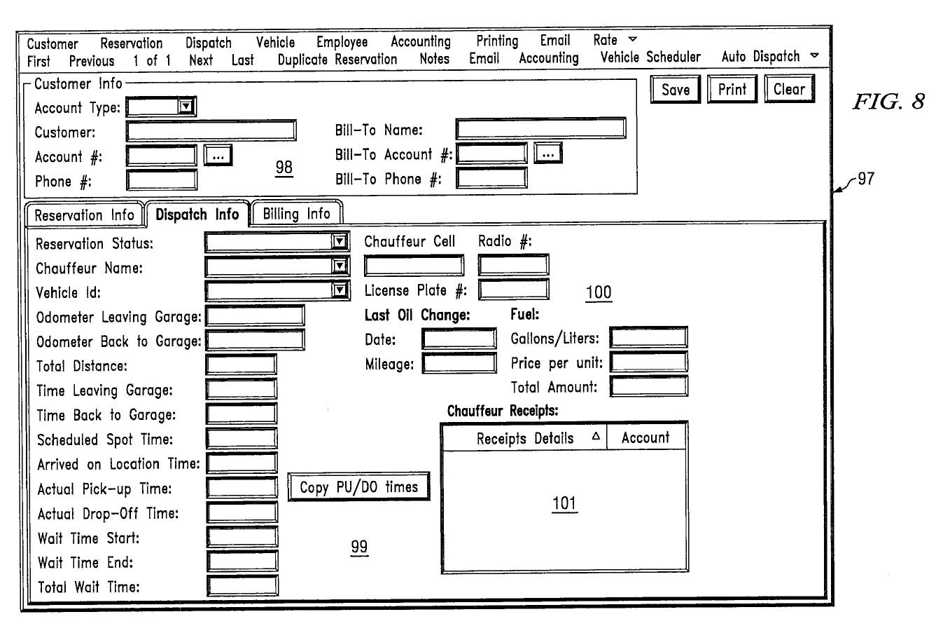

In block 86, the transportation service system 10 presents a list of vendor rental resources that match or closely align with the reservation inquiry. The listing shown in FIG. 7 represents the vendor rental resources that match or closely align with the reservation inquiry.

System 10 further calculates the rate for use of the rental resources based on the reservation information and vendor-supplied information. The rates are calculated based on estimated time and distance to perform the transportation service. The rate calculation takes into account vehicle type, driving route, actual distance, road conditions, weather, construction, traffic, fuel consumption, price of fuel, and driver's compensation. The information is derived from the vendor, reservation, and other sources.

Consider an example rate calculation done in conjunction with the map shown in FIG. 6. Assume the reservation involves transportation services between point 90 (airport) and point 95 (hotel) on the map. The customer requests a limousine for four passengers plus luggage. In determining the rate calculation, the transportation service system 10 must determine the proper route from origin to destination. The route is selected based on most efficient driving time, distance, cost, and safety for the passengers. The best route is not always the shortest in time or distance. System 10 considers road conditions, predictable travel delays (rush hour), construction delays, weather, and other factors that might adversely influence the travel experience for the customer.

The transportation service system 10 selects the route shown in FIG. 6. The route is divided into segments to aid in the distance measurement. The first segment of the trip from point 90 to point 91 is five miles. System 10 can review public records to determine that the road from point 90 to point 91 is a straight and level boulevard with six traffic lights. However, because of the time of day, the route from point 90 to point 91 is expected to be the height of rush hour traffic and experience traffic delays accordingly. The route must turn left at point 91 and proceed ten miles to point 92 because of a mountain in area 93. The road between point 91 and point 92 is a state highway with gradual change in elevation from sea level to 1000 feet. The road from point 92 to point 94 is twisting and winding with radical changes in elevations ranging from 1000-5000 feet over a distance of twenty miles necessary to traverse the mountain area 93. The road from point 94 to point 95 is a business district with heavy construction in certain areas. The distance from point 94 to point 95 is about fifteen miles and the average elevation is 3000 feet.

The transportation service system 10 takes into account many of the physical conditions along the route between point 90 and point 95. The actual physical distance can be accurately measured using public records. The physical distance is the actual distance to be traveled, taking into account street grid, surrounding structures, changes in direction, and detours. The physical distance also reviews geological conditions, i.e., changes in elevation, as movement in the third dimension (altitude) adds distance to the trip. If the route goes over a mountain, the distance is longer. The longer the distance, the greater the rate for use of the transportation services. In the present example, the distance from point 90 to point 95 is fifty miles taking into account the actual route and changes in elevation.

System 10 estimates the time to travel the route based on distance, traffic, and road conditions. Dirt roads can take more time than city streets, which can take more time than highways, which can take more time than freeways. Traffic plays a major role in determining travel time. The heavier the traffic for the road capacity, the greater the travel time. Other factors that affect travel time include weather, construction, and speed variation of the vehicle. Adverse weather conditions such as snow, rain, and storms, can significantly increase travel time. Construction delays can add time to traverse the route. These predictable travel delays can be updated in real-time by communicating with public service stations, e.g., weather, traffic, accident, and construction information sources. In the present example, the distance from point 90 to point 95 is fifty miles taking into account the actual route and changes in elevation. The time to travel from point 90 to point 95 is one hour taking into account the distance, traffic, and road conditions.

System 10 estimates fuel consumption based on distance and terrain over the route. The greater the distance, the greater the fuel consumption. The vehicle consumes more fuel traversing mountain regions than flat terrain. The vehicle consumes more fuel bucking headwinds or passing through snow and rainstorms than it does in clear weather. The larger the vehicle and more weight being carried, the higher the fuel consumption. Fuel costs are considered with the fuel consumption. The more difficult or congested the road conditions and higher the fuel consumption and fuel prices, the greater the rate.

The rate calculation considers the driver's time and rate. Some drivers are paid by the hour; some drivers are paid a flat rate for a given trip. The compensation for drivers can vary with experience level and popularity with the customers.

The rate calculation considers all the real factors that influence the total cost associated with operating the vehicle over the route, including vehicle type, time, distance, fuel, and driver compensation. The factors for the rate calculation can be updated real-time as conditions change. The user can even get an updated rate calculation while en route to their destination. System 10 will compute the rate directly based on the above real conditions or adjust a base rate by a calculated percentage increase based on the factors described above. For example, the fifty miles from point 90 to point 95 over one hour with all the above factors may come to $250. Alternatively, if the base rate for the limousine for the trip from point 90 to point 95 is $200, the rate may be increased by 20% for adverse weather and construction delays. The rate calculation may also factor in the varying consumer price index for inflationary variances.

System 10 calculates rates for each rental resource that is available and matches the reservation inquiry. The calculated rates are the estimated pricing provided to the customer.

A table of possible rental resources is sent back to retail customer 50. The rental resources that match the reservation criteria are displayed for retail customer 50 with estimated pricing in rental resource list 96 as shown in FIG. 7. The list includes vendor name, rate, and vehicle type. Retail customer 50 can review the available rental resources within the geographical area and make the desired selection. Once making the selection, the system displays the relevant reservation information, including the selected rental resource, for the customer's review. The customer confirms the reservation as selected. System 10 may request additional information from retail customer 50 such as payment options, passenger information, and any special instructions. System 10 may provide one more reservation review and confirmation for the customer to make sure all reservation information is correct. Retail customer 50 is then given a reservation confirmation number. A rental agreement is sent to the customer via email, facsimile, or postal service for signature. A digital signature is also available. The transportation service system 10 further handles any cancellation or modification of the reservation requested by the customer. In the event of a change, the database records are updated to maintain current status of the rental resource.

The confirmed reservation information is sent to the vendor of the selected rental resource. The reservation information is processed in the vendor's back office to reserve the rental resource according to the reservation. The vendor reservation information is shown in FIG. 8. Data entry screen or webpage 97 has block 98 with fields for customer information such as account type, customer name, account number, phone number, bill-to name, bill-to account, and bill-to phone number. Under the dispatch info tab, in block 99, the user has fields for reservation status, chauffeur name, chauffeur phone number, radio number, vehicle lot, license plate, odometer leaving garage, odometer back to garage, total distance, time leaving garage, time back to garage, schedule spot time, arrived on location time, actual pick-up time, actual drop-off time, wait time start, wait time end, and total wait time. Block 100 shows vehicle maintenance information such as last oil change and fuel consumption. Block 101 shows chauffeur receipts. Some fields are for user data entry and other fields are determined by the system.

The transportation services are rendered to retail customer 50, i.e., the driver picks up the customer at the designated time and location and takes the customer where he or she wants to go. Depending on the circumstances, the actual charges may be different from the estimated pricing given to the customer. For example, the customer may change his plans while en route causing additional time and mileage to be incurred. Natural or man-made delays in the form of weather and construction obstacles may be experienced. When the driver completes the transportation services, the actual charges are updated in system 10.

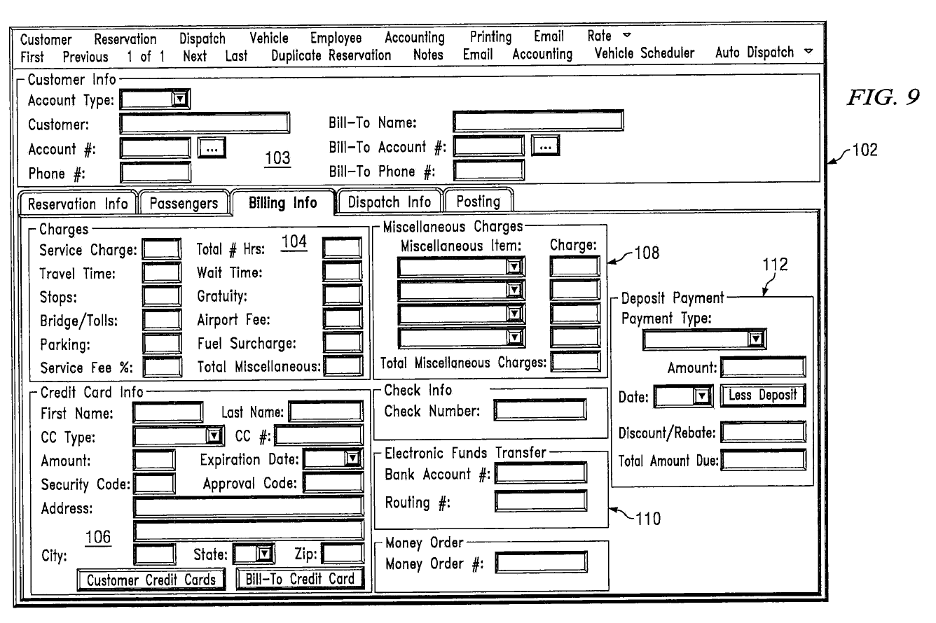

The vendor uses data entry screen or webpage 102 as shown in FIG. 9 to enter billing information before and after the transportation services are rendered. Screen 102 has block 103 for customer information fields such as account type, customer name, account number, phone number, bill-to name, bill-to account, and bill-to phone number. Under the billing info tab, in block 104, the user has fields for service charge, travel time, stops, tolls, parking, service fees, total hours, wait time, gratuity, airport fee, fuel surcharge, and total miscellaneous. In block 106, screen 102 has fields for credit card name, type, number, amount to be charged, expiration date, security code, approval code, and customer address. In block 108, screen 102 provides for miscellaneous charges. In block 110, the user has fields for check number, bank account and routing number for electronic funds transfer, and money order number. In block 112, the user has fields for deposit payment type, amount, date, discount, rebate, and total amount due.

The billing system supports customer accounts and sub-accounts. System 10 can generate credit card authorization and send reports formatted to any accounting system.

The billing for the transportation services rendered to retail customer 50 are posted by the vendor and sent back to the transportation service coordinator for reconciliation and payment. The customer's credit card is charged or the customer is invoiced for payment. The customer makes payment to the transportation service coordinator, who utilizes automated clearing house (ACH) banking services to reconcile vendor accounts receivable. Each vendor may have completed multiple reservations through the transportation service coordinator. System 10 matches up customer payments with vendor invoices and ensures that the accounts are reconciled. The vendor will receive one aggregate payment from the transportation service coordinator as settlement of all outstanding invoices for the given billing cycle.

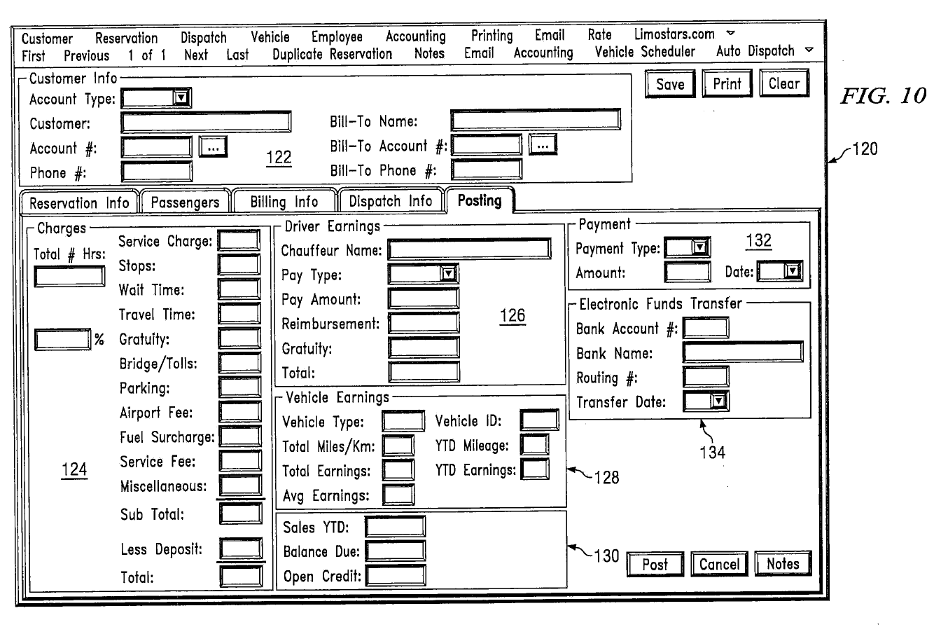

FIG. 10 illustrates data entry screen or webpage 120 for posting the final charges for the transportation services rendered. Screen 120 has block 122 for customer information fields such as account type, customer name, account number, phone number, bill-to name, bill-to account, and bill-to phone number. Under the posting tab, in block 124, the user has fields for charges such as total number of hours, service charge, stops, wait time, travel time, gratuity, bridge tolls, parking, airport fee, fuel surcharge, service fee, miscellaneous, deposit, and total charges. In block 126, screen 120 provides fields for driver earnings such as chauffeur name, pay type, pay amount, reimbursement, gratuity, and total. In block 128, screen 120 provides fields for vehicle earnings such as vehicle type, vehicle ID, total miles, year-to-date (YTD) mileage, total earnings, YTD earnings, and average earnings. In block 130, the user has fields for sales YTD, balance due, and open credit. In block 132, the user has fields for payment type, amount, and date. In block 134, the user has fields for bank account number, bank name, routing number, and transfer date. Some fields are for user data entry and other fields are determined by the system.

Retail customer 50 also gets a survey to evaluate the transportation service. The survey is important as a quality check and client feedback to improve services. The surveys are stored in database 60 and a rating is generated for each vendor.

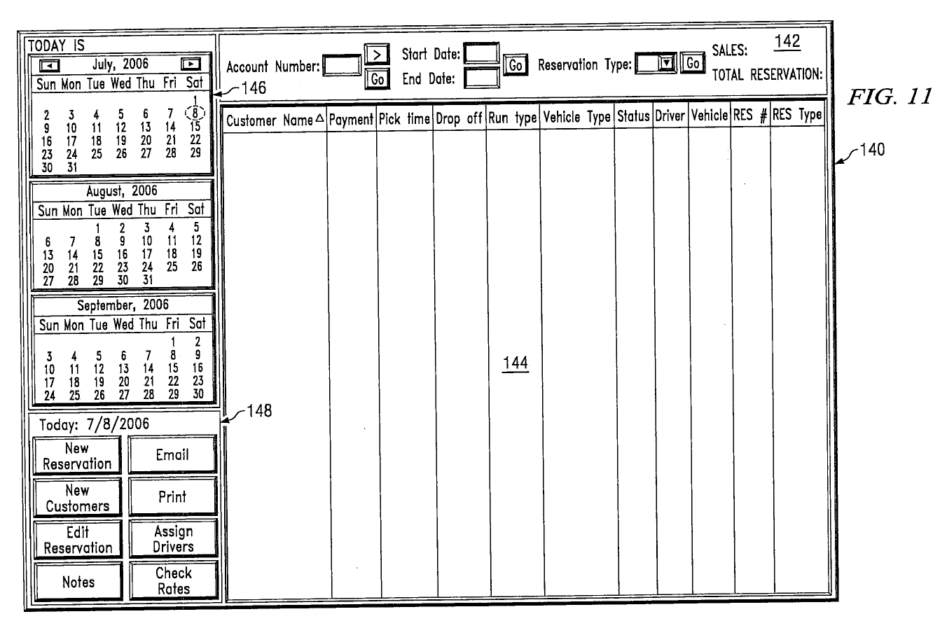

The transportation service system 10 can run reports for the vendors and customers alike. In FIG. 11, data entry screen or webpage 140 has block 142 which provides fields for account number, start date, end date, and reservation type. The report shows reservation activity for a given vendor. The report lists customer name, payment, pick-up time, drop-off time, run type, vehicle type, status, driver, vehicle, reservation number, and reservation type in block 144. Block 146 shows calendars. Selection boxes 148 allow the user to manage the reservations by entering a new reservation, email, new customers, print, edit reservation, assign drivers, notes, and check rates. Some fields are for user data entry and other fields are determined by the system.

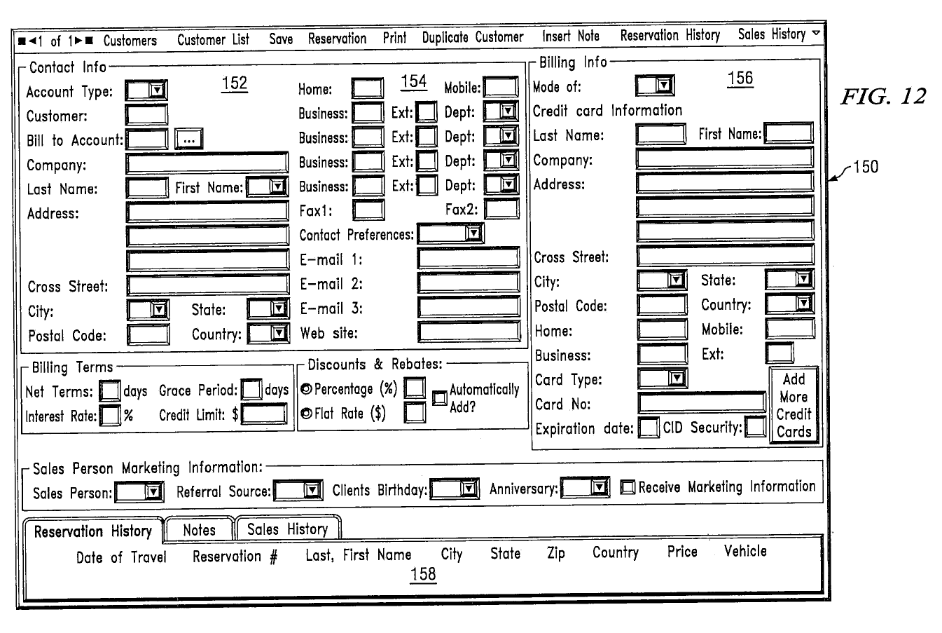

The transportation service system 10 also provides for historical reporting. In FIG. 12, data entry screen or webpage 150 has fields for reservations based on account type, customer, bill-to account, company, customer name, customer address, billing terms, and marketing in block 152. In block 154, the user has fields for phone numbers and email addresses. In block 156, the user has fields for billing information such as credit card name, company, address, phone numbers, card type, card number, expiration date, and security code. The historical reporting for reservations is presented in block 158. Some fields are for user data entry and other fields are determined by the system.

One of the features of the transportation service system 10 is the ability to provide useful travel-related tools or logistical services to the customer before, during, and after the rendition of transportation services. The travel-related tools are made available to the customer individually or collectively depending on the service level needs of the customer.

FIG. 13 illustrates a number of the travel-related tools available to customer 168 through the transportation service system 10. Some tools are available through the website or application software, other tools can be accessed by wireless communication device.

One resource available to customers through system 10 is directory tool 170. The directory helps the customer find points of interest such as addresses, landmarks, banking services, gas stations, clubs, shows, restaurants, theatres, hotels, and airlines. For example, if the customer needs directions to a business address, the directory tool will provide detailed driving directions as well as a map. If the customer is already en route, the directory tool can be accessed by wireless communication device to get the requested information.

The transportation service system 10 is fully integrated into wireless networks such as cellular phones, global positioning system (GPS), radio frequency identification (RFID), and personal digital assistant (PDA), as well as bridging technology between these devices. Through wireless communication tool 172, customer 168 can access real-time weather, traffic, and obstacle reports (accidents and construction) for any geographic locale. Traffic reporting tool 174 gives up-to-the-minute traffic status. The traffic report includes congested areas, accidents, and alternative routes. Weather reporting tool 176 gives current weather and road conditions. The weather report includes temperature, precipitation, forecast, and advisories. The traffic and weather reports can also estimate time to destination or estimate time of arrival. System 10 can provide driving directions to any destination and update such direction if the plans or conditions change.

The ancillary reservations tool 178 allows customer 168 to make reservations for the points of interest before departing or while en route. Customer 168 can make dinner reservations or purchase theatre tickets. System 10 can book tickets and check flight departure and status for airlines and other common carriers.

System 10 provides real-time dispatching tool 180 for transportation services. System 10 can track the location of each rental resource, show present location, check availability and time schedule, and immediately dispatch the resource to the customer upon demand. A customer can request transportation services and have the closest vehicle and driver, as determined by GPS tracking to longitude and latitude coordinates, immediately dispatched to the desired location. System 10 shows the vehicle en route and status of passengers on-board. With the real-time dispatching, the driver can proceed directly to the customer location at the beginning of each shift without having to stop by the vendor office.

System 10 presents special deals and promotions to customers with tool 182. System 10 also supports offers for business where the customer can name his own price or bid for transportation services and see if any vendor responds.

In addition to the services offered for retail customers, the transportation service system 10 provides additional support for corporate customers with corporate service tool 184. The corporate customer may issue requests for proposal (RFP) to vendors for annual contracts for transportation services. The vendors would bid for the annual contracts. The annual contract would specify approved vendors, pricing, and support company review of the services rendered. System 10 could create vendor databases for each vendor. System 10 would support group reservations. System 10 can be web-based for remote log-in by authorized employees or be provided as a dedicated software package. System 10 supports administrative rights and is given full control over the system, e.g., valid data entry fields and values.

Corporate customers can interact with the transportation service system 10 via virtual private network (VPN) and use global digital system (GDS) or other legacy system for booking. System 10 supports direct billing for corporate customers, full accounting suite, quality assurance (QA) tools, and customer relationship management (CRM) tools.

The transportation service system 10 also supports vendor to vendor transactions with vendor services tool 186. Most vendors have a finite service area. The rental company may be located in a particular city, and possibly have a branch office in other locations. However, the vendor is unlikely to have offices in every city, worldwide. Even for the larger vendors servicing multiple markets, they may not have the desired rental resources in the location of interest for the customer. With that said, most if not all cities have at least one vendor with the desired rental resources. Accordingly, one vendor may want to transfer reservations to another vendor. The transportation service system 10 provides the feature of transferring reservations from one vendor, who is unable to service a customer, to another vendor that can service the customer.

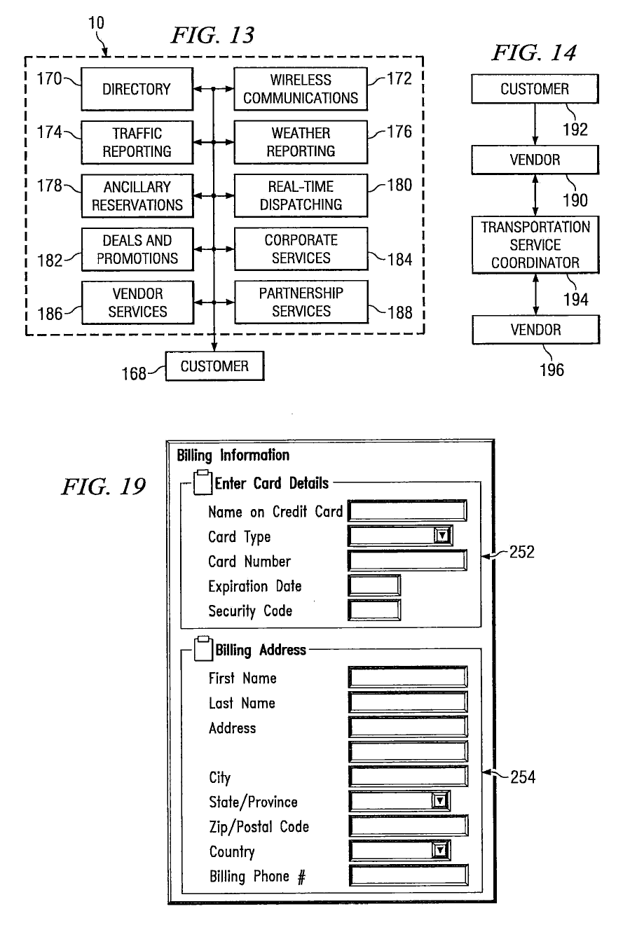

Referring to FIG. 14, vendor 190 receives a reservation request from customer 192. To handle situations where vendor 190 cannot provide the requested rental resources, the transportation service coordinator 194 establishes relationships or affiliations between vendors to provide the capability to transfer reservation requests. The transportation service coordinator operates the transportation service system 10 as described herein. As shown in FIG. 14, service coordinator 194 has affiliations with vendor 190 and vendor 196. The relationship takes the form of an agreement between vendors 190 and 196, which has been established by and is continuously managed by service coordinator 194. In the agreement, if vendor 190 cannot provide transportation services to a customer which originated the reservation inquiry with vendor 190, then vendor 196 agrees for service coordinator 194 to offer the rental resources of affiliated vendor 196 in place of vendor 190. If the customer accepts the reservation and vendor 196 provides the transportation services to the customer that originated with vendor 190, then vendor 196 will share the revenue with vendor 190. Service coordinator 194 also takes a share of the revenue for providing the reservation transfer service. Service coordinator 194 may offer other affiliated vendors to fill the reservation inquiry to give the customer 192 multiple choices. The reverse scenario holds true for vendor 196 transferring reservations to vendor 190 when it cannot fill the order.

Consider an example where vendor 190 is located in Phoenix, Ariz. Customer 192 is traveling to London, England, and needs transportation services at that location. Vendor 190 has no rental resources in London. Vendor 190 still wants to maintain its relationship with customer 192 and fill its reservation request. In another example, customer 192 may want to reserve a limousine in Phoenix, but vendor 190 has no vehicles available. In either case, vendor 190 cannot fill a reservation request from customer 192. To meet the customer's needs, service coordinator 194 transfers the reservation request to affiliated vendor 196. An affiliated vendor is one that has been pre-approved within system 10 in terms of level of service and quality, and agrees to share revenue with the originating vendor. The transportation service coordinator oversees the reservation inquiry for the customer as described above once the first vendor determines that it cannot provide the service to the customer. A portion of the payment made by customer 192 goes to vendor 196, typically the majority of the revenue since it is providing the transportation service. A portion of the payment goes to vendor 190 for originating the order through its relationship with customer 192. The reservation transfer feature allows vendor 190 to satisfy its customer in virtually all situations while utilizing the transportation service system 10 to fill that need.

In other vendor-to-vendor transactions, system 10 can operate as a private label (no branding) or branded label. A vendor's website can have a link to the transportation service system website. Any user logging into the vendor system can link to the transportation service system 10 and access a reservation screen. Alternatively, a data entry screen can be imported into the vendor's website. In any case, the customer can make a reservation request for rental resources as described above. If the reservation request is in the vendor's service area, then only the vendor's rental resources are presented to the customer. If the reservation is outside the vendor's service area, then system 10 will present other rental resources for consideration by the customer, provided the other rental resources are willing to participate in revenue sharing. If the reservation goes to another vendor, then the transportation service coordinator will share the revenue proceeds from the customer between the originating vendor and the vendor providing the services.

The transportation service system 10 also forms partnerships with other service providers such as search engines, travel sites, travel agencies, and affiliates. Partnership services tool 188 in FIG. 13 supports the partners to system 10. The other service providers can operate their own website with a link to the transportation service system 10. The partners will refer customers to the transportation service system 10. Each partner will have its own partner account and participate in revenue sharing for reservation traffic it refers.

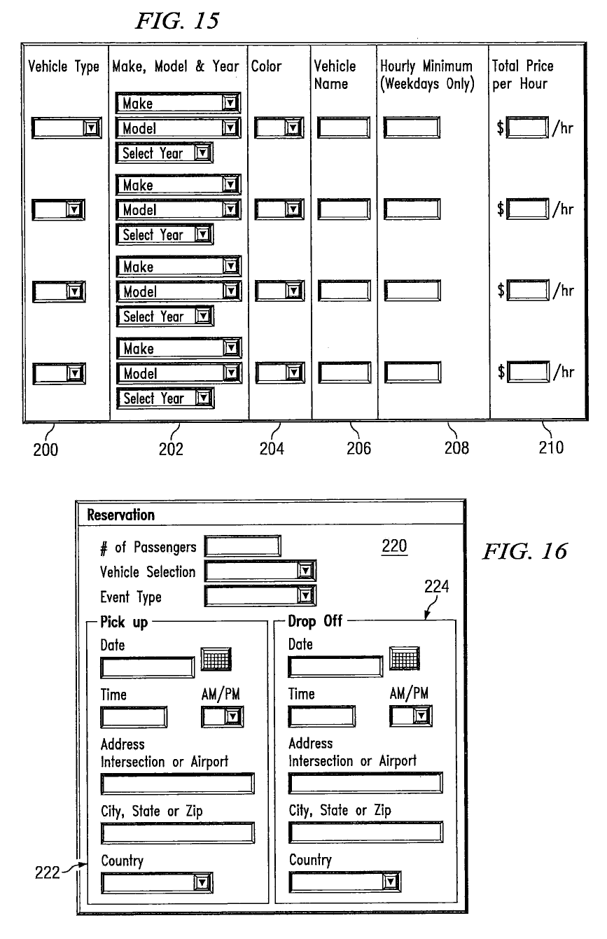

FIGS. 15-23 illustrate an alternate stream-lined implementation of transportation service system and process 10.

FIG. 15 is a data entry screen for the vendor to enter vehicle information regarding its rental fleet as records into database 60 to allow customer 50 to search on available transportation services and make reservations through the transportation service coordinator. Block 200 has fields for the vendor to enter vehicle type. Block 202 has fields for make, model, and year; block 204 has fields for color specification; block 206 has fields for vehicle name; block 208 has fields for hourly minimum; and block 210 has fields for total price per hour. Once the vehicle information is entered as records in the transportation service coordinator's database, customer 50 can search for available transportation resources and make selections.

FIG. 16 is a data entry screen for customer 50 to make reservations for transportation services through the transportation service coordinator. Block 220 has fields for number of passengers, vehicle selection, and event type. Block 222 has fields for passenger pickup information such as date, time, and address. Block 224 has fields for passenger drop-off information such as date, time, and address. From the data entry screen of FIG. 16, the system 10 can determine what vendor best suits the customer's needs.

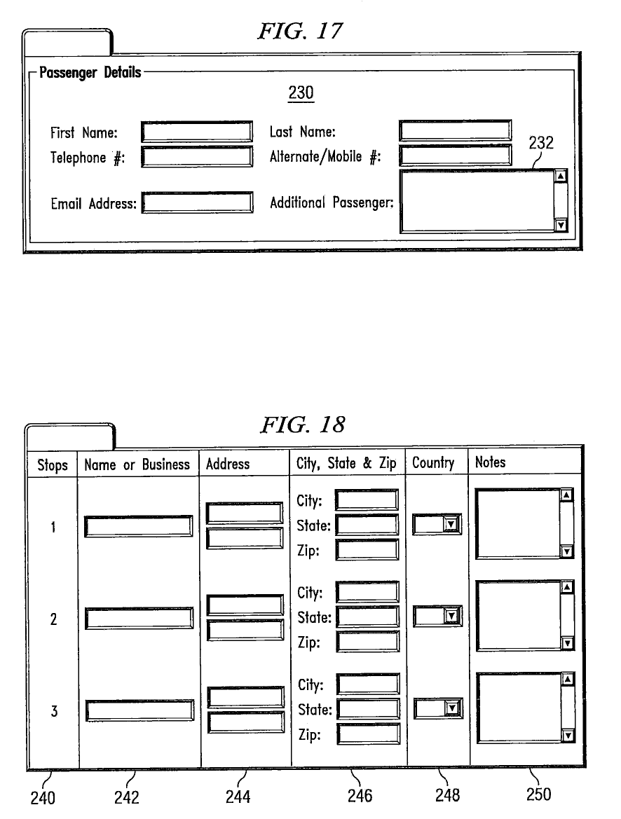

FIG. 17 is a data entry screen for customer 50 to provide passenger information. Block 230 has fields for passenger first name, last name, telephone number, and email. Field 232 accepts additional passenger information. From the data entry screen of FIG. 17, the transportation service coordinator can determine the basic passenger information, which in combination with the vehicle and timing information of FIG. 16, can be used to further refine the search of available transportation resources that meet the customer's needs.

FIG. 18 is a data entry screen for the transportation service itinerary. Block 240 identifies the order of stop en route from origin to final destination. Block 242 has fields for name of business; block 244 has fields for address; block 246 has fields for city and state; block 258 has fields for country; and block 250 has fields for notes. From the data entry screen of FIG. 18, the transportation service coordinator can determine the basic trip information, which in combination with the passenger, vehicle, and timing information of FIGS. 16 and 17, can be used to further refine the search of available transportation resources that meet the customer's needs.

FIG. 19 is a data entry screen for billing information. Block 252 has fields for credit card information. Block 254 has fields for customer billing address. The transportation service coordinator uses the billing information to bill the customer and reconcile vendor invoices.

The vendors that have transportation resources that match the reservation requested are provided to customer 50. The customer then selects the vendor, and the reservation, passenger, and trip itinerary data entered in FIGS. 17-19 is forwarded to the selected vendor.

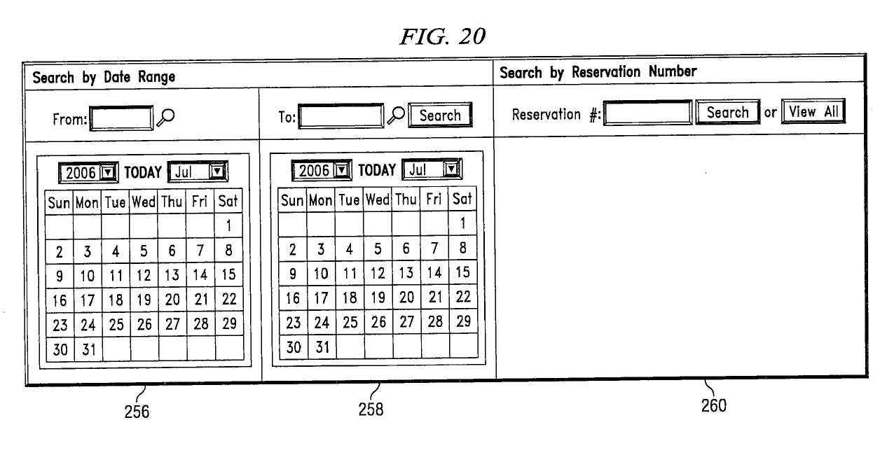

Once the reservation is made, FIG. 20 can be used to search for existing reservation information. Blocks 256 and 258 have fields for from/to date ranges. Block 260 has fields for specific reservation numbers.

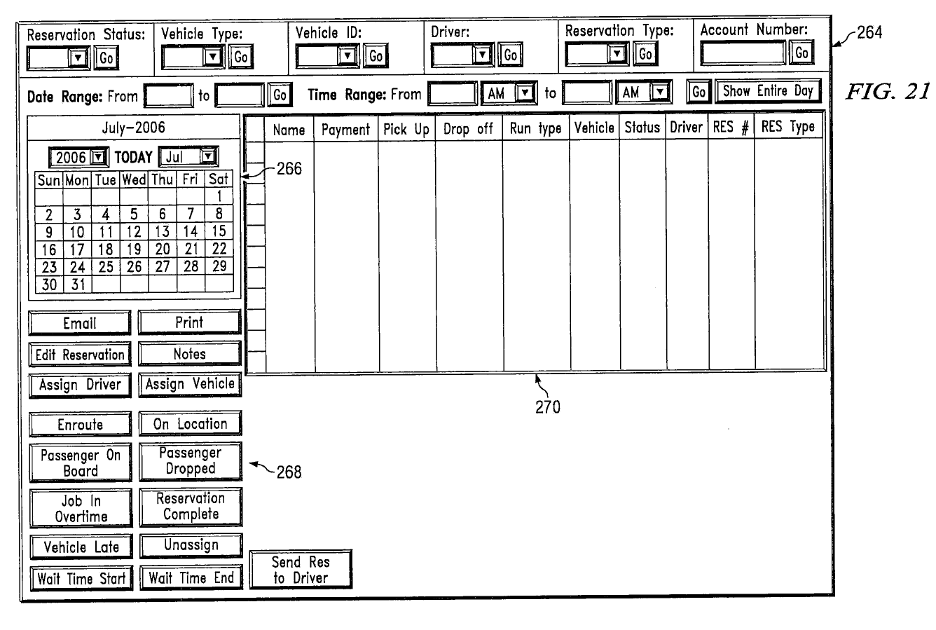

FIG. 21 illustrates a report of existing reservations. Block 264 has search fields for reservation status, vehicle type, vehicle ID, driver, reservation type, account number, date range, and time range. Block 266 is a calendar for easy selection of desired date. Block 268 has function selection buttons for email, print, edit reservation, notes, assign driver, assign vehicle, en route, on location, passenger on-board, passenger dropped off, job in overtime, reservation complete, vehicle late, unassign, wait time start, wait time end, and send reservation to driver. Block 270 is the report body in accordance with the search fields including name, payment, pickup, drop-off, run type, vehicle, status, driver, reservation number, and reservation type.

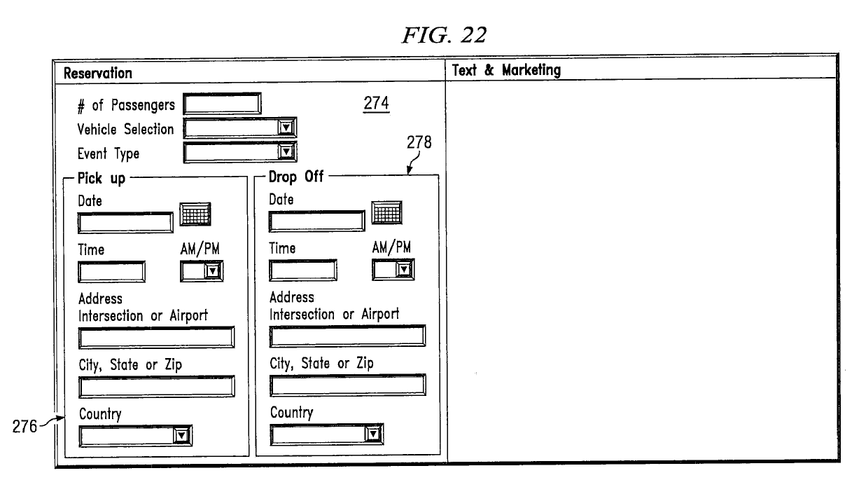

FIG. 22 is a data entry screen for farming out reservations to affiliated vendors within the system. When a particular vendor cannot service a customer, the system can farm-out the reservation to another approved vendor in the system. Block 274 has fields for number of passengers, vehicle selection, and event type. Block 276 has fields for passenger pickup information such as date, time, and address. Block 278 has fields for passenger drop-off information such as date, time, and address. From the data entry screen of FIG. 22, the transportation service coordinator can transfer a reservation to another affiliated vendor within the system and still service the customer's needs.

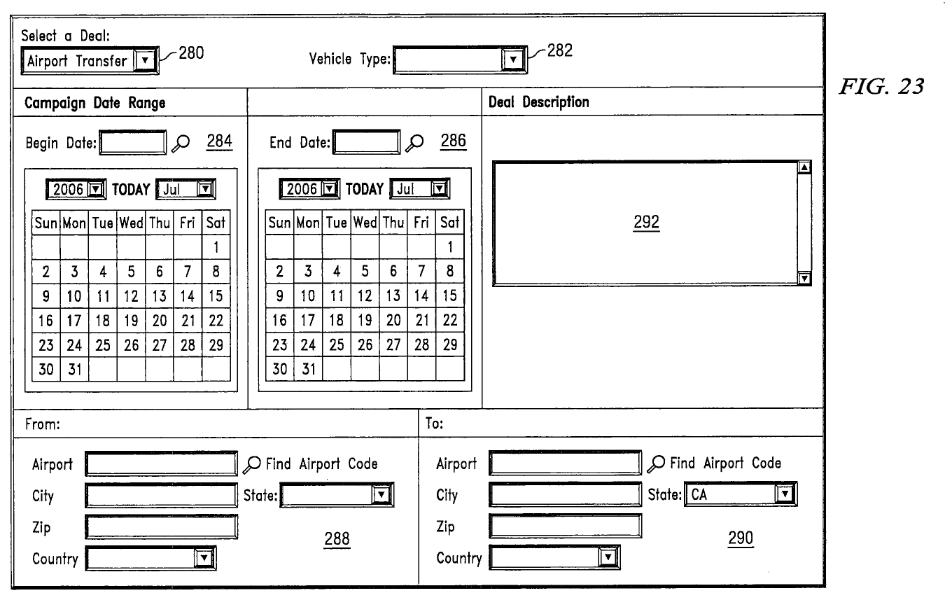

FIG. 23 is a data entry screen for special deals available through transportation service process 10. Field 280 allows customer 50 to select a deal. Field 282 allows customer 50 to select a vehicle type. In the present example, the deal is for an airport transfer. Blocks 284 and 286 have fields to select begin and end date range. Blocks 288 and 290 have fields to select from/to airports. From the data entry screen of FIG. 23, the transportation service coordinator can provide useful special deals to customer 50.

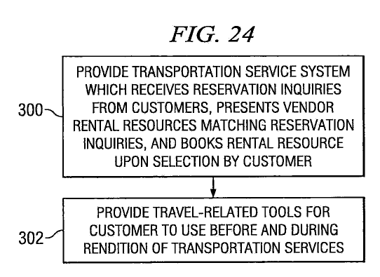

FIG. 24 illustrates the steps involved in providing travel-related tools for use with transportation services. In step 300, a transportation service system is provided which receives reservation inquiries from customers, presents vendor rental resources matching the reservation inquiries, and books the rental resource upon selection by the customer. In step 302, a plurality of travel-related tools is provided for the customer to use with the transportation services. The travel-related tools are useful before and during rendition of the transportation services. The travel-related tools are accessible by wireless communications. The travel-related tools includes a directory for locating points of interest, a traffic reporting tool for providing current traffic information, and a weather reporting tool for providing current weather information and road conditions. The travel-related tools provide driving directions to any destination. The travel-related tools can make ancillary reservations. The travel-related tools further include a real-time dispatching of transportation services, corporate services to providing features for corporate customers, and partnership services to providing features for partners of the transportation service system.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of providing travel-related tools for use with transportation services, comprising:
providing a transportation service system which receives reservation inquiries from customers, presents vendor rental resources matching the reservation inquiries, and books the rental resource upon selection by the customer; and
providing a plurality of travel-related tools for the customer to use before and during rendition of the transportation services.

2. The computer-implemented method of claim 1, wherein the plurality of travel-related tools are accessible by wireless communications.

3. The computer-implemented method of claim 1, wherein the plurality of travel-related tools includes a directory for locating points of interest.

4. The computer-implemented method of claim 1, wherein the plurality of travel-related tools includes:
a traffic reporting tool for providing current traffic information; and
a weather reporting tool for providing current weather information and road conditions.

5. The computer-implemented method of claim 1, wherein the plurality of travel-related tools provides driving directions to a destination.

6. The computer-implemented method of claim 1, wherein the plurality of travel-related tools provides for making ancillary reservations.

7. The computer-implemented method of claim 1, wherein the plurality of travel-related tools includes a real-time dispatching of transportation services.

8. The computer-implemented method of claim 1, wherein the plurality of travel-related tools provides deals and promotions for transportation services.

9. The computer-implemented method of claim 1, wherein the plurality of travel-related tools includes providing corporate services for corporate customers.

10. The computer-implemented method of claim 1, wherein the plurality of travel-related tools includes providing partnership services for partners of the transportation service system.

11. A computer-implemented method of providing travel-related tools for use with transportation services, comprising:
providing a transportation service system for booking rental resources; and
providing a plurality of travel-related tools for use during rendition of the transportation services.

12. The computer-implemented method of claim 11, wherein the plurality of travel-related tools are accessible by wireless communications.

13. The computer-implemented method of claim 11, wherein the plurality of travel-related tools includes a directory for locating points of interest.

14. The computer-implemented method of claim 11, wherein the plurality of travel-related tools includes:
a traffic reporting tool for providing current traffic information; and
a weather reporting tool for providing current weather information and road conditions.

15. The computer-implemented method of claim 11, wherein the plurality of travel-related tools includes a real-time dispatching of transportation services.

16. The computer-implemented method of claim 11, wherein the plurality of travel-related tools includes providing corporate services for corporate customers.

17. The computer-implemented method of claim 11, wherein the plurality of travel-related tools includes providing partnership services for partners of the transportation service system.

18. A computer program product usable with a programmable computer processor having computer readable program code embodied therein, comprising;
computer readable program code which provides for a transportation service system which receives reservation inquiries from customers, presents vendor rental resources matching the reservation inquiries, and books the rental resource upon selection by the customer; and
computer readable program code which provides a plurality of travel-related tools for the customer to use before and during rendition of the transportation services.

19. The computer program product of claim 18, wherein the plurality of travel-related tools includes a directory for locating points of interest.

20. The computer program product of claim 18, wherein the plurality of travel-related tools includes a real-time dispatching of transportation services.

21. The computer program product of claim 18, wherein the plurality of travel-related tools includes corporate services for providing features for corporate customers.

22. The computer program product of claim 18, wherein the plurality of travel-related tools includes partnership services for providing features for partners of the transportation service system.

23. A computer system for providing travel-related tools for use with transportation services, comprising;
means for providing a transportation service system which receives reservation inquiries from customers, presents vendor rental resources matching the reservation inquiries, and books the rental resource upon selection by the customer; and
means for providing a plurality of travel-related tools for the customer to use before and during rendition of the transportation services.

24. The computer system of claim 23, wherein the plurality of travel-related tools are accessible by wireless communications.

25. The computer system of claim 23, wherein the plurality of travel-related tools includes a directory for locating points of interest.

26. The computer system of claim 23, wherein the plurality of travel-related tools includes a real-time dispatching of transportation services.

27. The computer system of claim 23, wherein the plurality of travel-related tools includes corporate services for providing features for corporate customers.

28. The computer system of claim 23, wherein the plurality of travel-related tools includes partnership services for providing features for partners of the transportation service system.
